(19) United States
(12) Patent Application Publication
(10) Pub. No.: US 2019/0014736 A1
(43) Pub. Date: Jan. 17, 2019

(54) Pet Carrier Cart with Four Spinner Wheels

(71) Applicant: Ann Greenberg, JR., New York, NY (US)

(72) Inventor: Ann Greenberg, JR., New York, NY (US)

(21) Appl. No.: 15/646,276

(22) Filed: Jul. 11, 2017

(51) Int. Cl. A01K 1/00; A45C 13/38

(52) U.S. Cl. CPC A01K 1/0035; A45C 13/385

(57) ABSTRACT

A combination foldable cart with a telescoping handle that includes four spinner wheels so that the base of the cart can move laterally in any direction without turning the cart. The invention also includes a pet carrier bag attachable and removable from the cart. The pet carrier bag can be supplied in many different shapes, styles and colors to suit both the tastes of the pet owner and to suit the size and type of pet. In general, there is an opening on the top or side of the bag so that at least the pet's head can protrude. The bag can be attached to the cart by a panel on the back of the carrier or any method including a strap around the handle, clips or any other attachment method.

### BACKGROUND

### Field of the Invention

The present invention relates generally to pet carriers and more particularly to a fold-up pet carrier cart and pet carrier bag combination.

### Description of the Prior Art

Carrier carts are known in the art. Almost all of them have two or sometimes four fixed wheels. These carts are used mostly to transport luggage, computers or other items. They are primarily designed to be tilted and pulled behind a person who is walking. They are not designed to be pushed flat. Pet bags are also known in the art. These are sometimes used to transport pets from one location to another or on a trip by carrying the bag. However, with the existing 2-wheel pet carriers the animal is leaning back which is anxiety-provoking for the pet.

It would be advantageous to have a cart with four spinner wheels that can move in any direction in combination with an attachable pet carrier bag or briefcase-like container where the pet's head and sometimes paws can protrude and the cart with carrier and pet are moving horizontally This would give the pet adequate air, and also allow the pet to relax and not be nervous in the carrier.

### SUMMARY OF THE INVENTION

The present invention relates to a combination foldable cart or trolley with a telescoping handle that includes four spinner wheels so that the base of the cart can move laterally in any direction without turning the cart. The invention also includes a pet carrier bag or case attachable and removable from the cart. The pet carrier bag can be supplied in many different shapes, styles and colors to suit both the tastes of the pet owner and the size and type of pet. In general, there is an opening on the top or side of the bag so that at least the pet's head can protrude.

The bag can be attached to the cart by any method including a sleeve on the back of the cart, a strap around the handle, clips or any other attachment method. In the preferred embodiment, there is a panel or sleeve on the back of the carrier that allows the carrier to slide down the handle of the cart/trolley. Once the pet owner arrives at their destination; the carrier is lifted off the handle and cart/trolley is folded. The cart is designed to accompany the pet carriers taking the weight off the pet owners shoulders and back.

The present invention provides a convenient way to transport pets in a way with more control than on a leash—It takes the weight off the pet owner's shoulder and back allowing them the freedom to transport their pet effortlessly. This is a way that is conformable for the pet and useful for the pet owner.

### DESCRIPTION OF THE FIGURES

Attention is now directed to several drawings the illustrate features of the present invention.

FIG. 1 shows an embodiment of the present invention in a use configuration with the telescoping handle extended and a pet in the pet carrier.

FIG. 2 shows a front view of an embodiment of the invention with the telescoping handle retracted and no pet.

FIG. 3 shows a back view of the embodiment of FIG. 2.

FIG. 4 shows a side perspective view of an embodiment of the cart with the handle extended and no pet carrier.

FIG. 5 shows a top view of the cart with the handle in a retracted and folded configuration.

FIG. 6 shows a bottom view of the embodiment of FIG. 4 with the four spinner wheels.

Several figures and illustrations have been provided to aid in understanding the present invention. The scope of the present invention is not limited to what is shown in the figures.

### DESCRIPTION OF THE PREFERRED EMBODIMENTS

The present invention relates to a foldable pet carrier cart that conveniently transports pets such as dogs and cats giving the pet owner more control over the pet than a leash, or in locations where leashes are not allowed or practical, while being conformable for the pet in that the pet does not have to walk.

The present invention includes two major parts—a foldable cart with four spinner wheels that allow the cart to move laterally in any direction and—a pet carrier bag, case or other container that rides on the base of the cart/trolley typically allowing the pet's head to protrude.

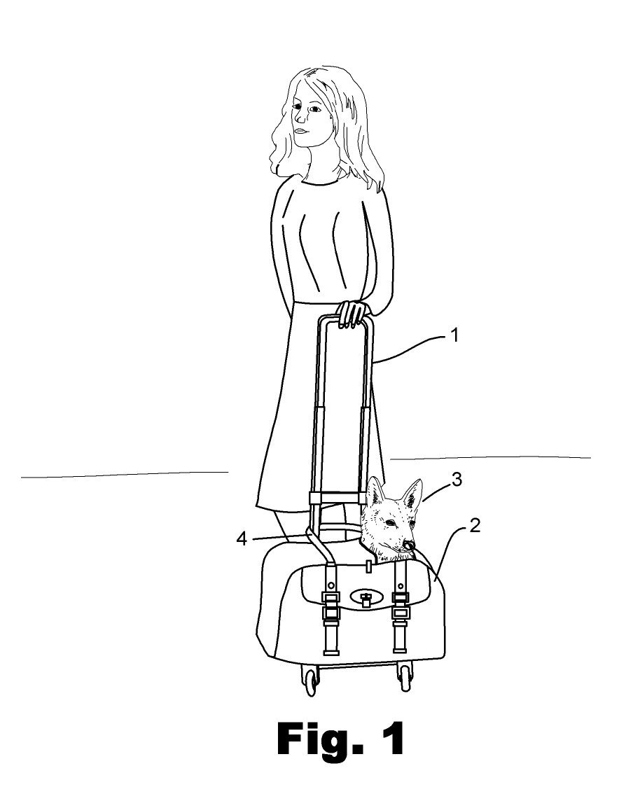

Turning to FIG. 1, an embodiment of the present invention can be seen in use transporting a dog. The pet owner holds the telescoping handle 1 of the device, and because of the four spinner wheels, the device can be moved in any direction desired by the pet owner. The pet 3 resides in the pet carrier bag 2 which is secured to the cart handle by the attached back panel or sleeve that includes a strap 4 that can circle around the handle 1. Any method for securing the pet carrier bag 2 to the cart is within the scope of the present invention including, but not limited to, straps, chains, clips or a panel/sleeve region that is attached to or is part of the pet carrier bag 2 that slips over the handle 1.

While the pet's head protrudes from one end of the top of the pet carrier bag 2 in FIG. 1, different embodiments of the invention allow the head to protrude from other locations such as the center of the top or even the side or ends of the bag 2.

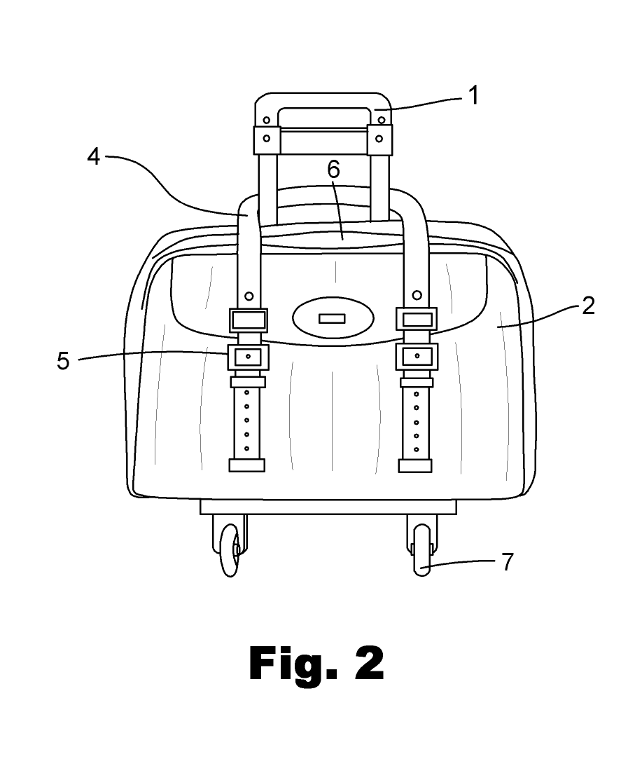

FIG. 2 shows a front view of the embodiment of FIG. 1 with the handle 1 retracted. Two of the four spinner wheels 7 can be seen. These wheels 7 are attached to a flat bottom of the cart. The pet carrier bag 2 rests on the base of the cart and, in this embodiment, is restrained to the cart handle 1 by a strap 4 that is adjustable with one or more buckles 5. As has been stated, the pet carrier bag 2 of FIG. 2 is merely to show one type of pet carrier that can be used. Pet carriers can be supplied in many different sizes, styles and colors and may be attached to the cart at any point any by any method. In some embodiments, the pet carrier bag can be attached to the cart on the bottom.

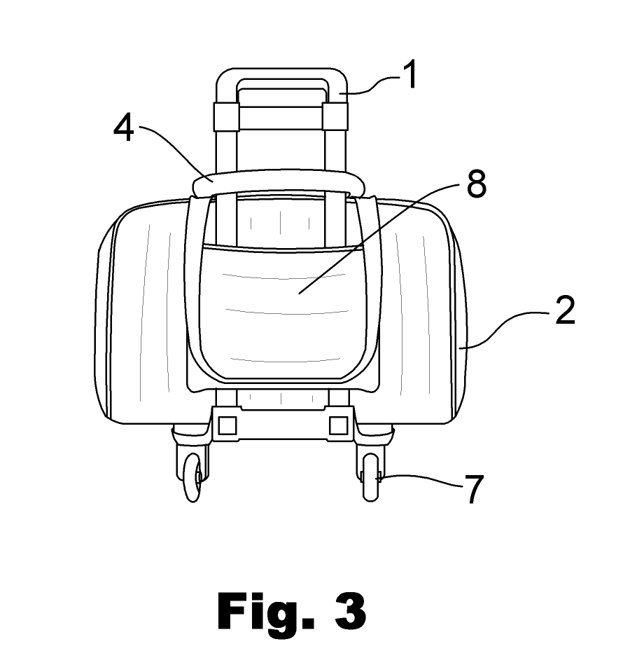

FIG. 3 shows a back view of the embodiment of FIG. 2. Here a panel/sleeve 8 is shown on the rear of the bag 2. The handle 1 slips through the sleeve 8 and is thus retained on the cart/trolley. An additional strap 4 is also shown; however, such a strap can be optional. When it is desired to fold the device, the pet carrier bag is simply raised off of the handle and removed.

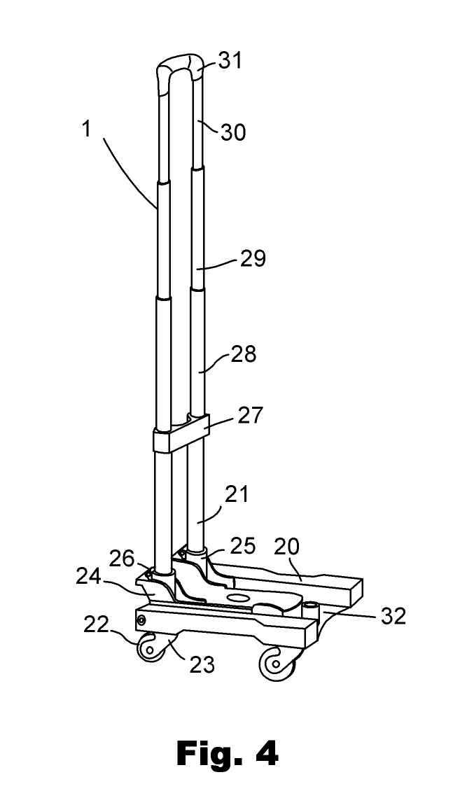

FIG. 4 shows a side perspective view of an embodiment of a cart with the pet carrier bag removed. The device has a base 32 with two side supports 20. The base 32 and side supports 20 can be made of any rigid material with molded plastic being preferred. A handle 1 is attached to the rear of the base 32 on a pair of hinges 26 secured to hinge holding flanges 24. These hinges 26 allow the handle 1 to be folded downward in a forward direction until it is parallel with the base 32 of the cart. With the handle 1 totally retracted, the device folds into an almost flat configuration for easy storage or transport.

The base 32 of the cart is equipped with four wheels 22 in swivel couplings 23 to form spinner wheels. This allows the base 32 to move in any direction by a simple push in the desired direction from the handle 1.

The handle 1 is shown in FIG. 3 with four telescoping sections. Any number of telescoping sections is within the scope of the present invention. The sections 21, 28, 29 and 30 are made from tubing of different sizes. Any rigid material may be used with aluminum being preferred. Any type of telescoping arrangement can be used with a pair of substantially parallel concentric tube sets being preferred. A hand grip 31 is attached on both sides of the parallel telescoping sections 30. Any number of intermediate supports or separators 27 may be used. In general, one is enough. Other telescoping methods are within the scope of the present invention including one or more than two tubes sets.

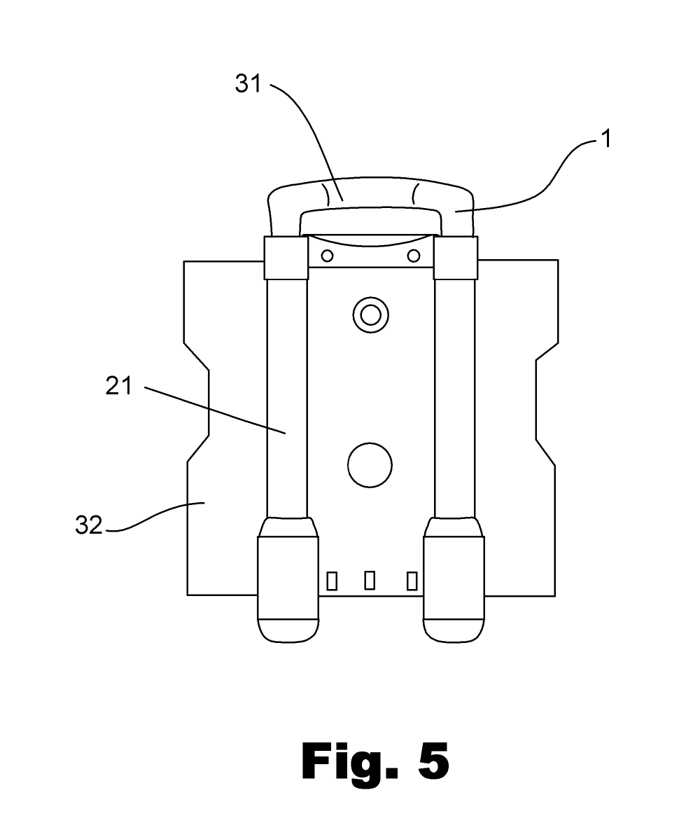

FIG. 5 shows a top view of the cart with the telescoping handle 1 totally retracted and folded into a configuration where the tubing 21 is parallel with the substantially rectangular base 32. In this retracted, folded configuration, the device takes up very little room to store or transport.

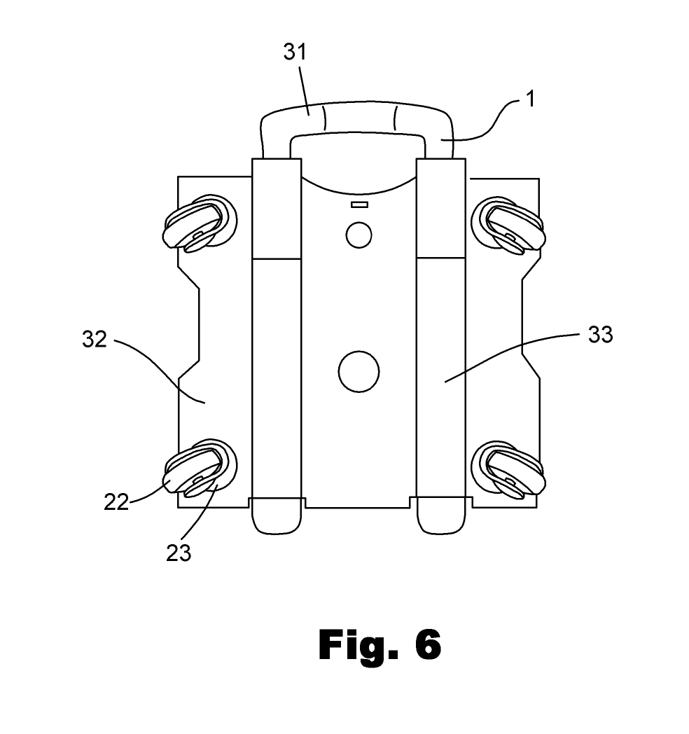

FIG. 6 shows the bottom of the embodiment of FIG. 4. The four spinner wheels can be seen attached to the four corners of the base 32. Each includes a wheel 22 and a caster or swivel coupling 23. The swivel couplings 23 are free to rotate allowing the wheels 22 to point in any direction. Each wheel is independent of the other wheels. The folded handle 1 fits into to two wells 33 when in the folded configuration. This allows the tubing to be parallel to the base 32. Typically, the hand grip 31 protrudes.

The present invention provides a convenient way to transport a pet on a cart with a pet carrier bag or other device. In generally, the pet's head can protrude from the bag so that the pet has air and is not nervous. The invention includes a cart with four spinner wheels that allow the cart to be pushed in any direction by the pet owner. The present invention provides a useful, safe way to transport a pet in a manner where the pet does not have to walk and it is not necessary to use a leash.

It should be understood, that while the preferred embodiments have used two parallel telescoping tubes for the cart/trolley handle, a single tube or other member could be used. Any type of extendable handle is within the scope of the present invention.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A wheeled pet carrier comprising:
a cart portion that includes a base and a telescoping handle, the handle having a non-telescoped configuration and a plurality of telescoped configurations, the handle including at least two telescoping sections formed from pairs of parallel tubing; the handle being hingedly attached to the base on a rearward side of the base so that the handle is telescopically extendable perpendicular to the base in an unfolded configuration and folds to a position parallel to the base in a folded configuration; wherein, the base has four spinner wheels constructed to allow the base to be displaced laterally in any direction;
a flexible pet carrier portion constructed to carry a pet with head extended out of the pet carrier, the pet carrier resting on the base and secured to the cart portion with a sleeve through which the cart handle passes.

2. The wheeled pet carrier of claim 1 wherein the sleeve on the pet carrier portion allows the carrier to slide down the cart's handle

3. The wheeled pet carrier of claim 1 wherein the cart portion includes four telescoping sections.

4. The wheeled pet carrier of claim 1 wherein the pet carrier portion includes an opening in its top.

5. The wheeled pet carrier of claim 4 wherein the opening is located at one end of the top.

6. The wheeled pet carrier of claim 1 wherein the pet carrier portion is secured to the cart portion on the cart base.

7. The wheeled pet carrier of claim 1 wherein the base is substantially rectangular.

8. A wheeled pet carrier comprising:
a cart portion that includes a substantially rectangular base and a telescoping handle, the handle having a non-telescoped configuration and a plurality of telescoped configurations, the handle including four telescoping sections; the handle being hingedly attached to the base on a rearward side of the substantially rectangular base so that the handle is telescopically extendable perpendicular to the base in an unfolded configuration and folds to a position parallel to the base in a folded configuration; wherein, the base has four spinner wheels constructed to allow the base to be displaced laterally in any direction;
a flexible pet carrier portion constructed to carry a pet with head extended out of the pet container, the pet container resting on the base and secured to the cart portion with a panel on the pet carrier through which the handle passes.

9. The wheeled pet carrier of claim 8 further comprising an adjustable strap.

10. The wheeled pet carrier of claim 8 wherein the telescoping handle is formed from a pair of substantially parallel concentric tube sets.

11. The wheeled pet carrier of claim 10 wherein the concentric tube sets are aluminum.

12. The wheeled pet carrier of claim 8 wherein the base is molded plastic.

13. A method of providing a wheeled pet carrier comprising:
providing a cart portion that includes a substantially rectangular base and a telescoping handle, the handle having a non-telescoped configuration and a plurality of telescoped configurations, the handle including four telescoping sections; the handle being hingedly attached to the base on a rearward side of the substantially rectangular base so that the handle is telescopically extendable perpendicular to the base in an unfolded configuration and folds to a position parallel to the base in a folded configuration; wherein, the base has four spinner wheels constructed to allow the base to be displaced laterally in any direction;
providing a flexible pet carrier portion constructed to carry a pet with head extended out of the pet carrier, the pet carrier resting on the base and secured to the cart portion with a sleeve through which the cart handle passes.

14. The method of claim 13 wherein the pet carrier portion is further secured to the cart portion with a strap.

15. The method of claim 13 wherein the cart portion includes four telescoping sections.

16. The method of claim 13 wherein the pet carrier portion includes an opening in its top.

17. The method of claim 16 wherein the opening is located at one end of the top.

18. The method of claim 13 wherein the pet carrier portion is secured to the cart portion on the cart base.

19. The method of claim 13 wherein the base is substantially rectangular.
